(19) United States
(12) Patent Application Publication
(10) Pub. No.: US 2007/0028162 A1
(43) Pub. Date: Feb. 1, 2007

(54) Reusing content fragments in web sites

(75) Inventors: William J. Griffin, Sammamish, WA (US); Bruce A. Jones, Des Moines, WA (US); Shiu-Kai Lee, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/192,791

(22) Filed: Jul. 30, 2005

(51) Int. Cl. G06F 15/00

(52) U.S. Cl. 715/513

(57) ABSTRACT

Reusable content fragments are managed in a web site. The reusable content fragments are saved in a reusable content library in response to the fragments being created in a web page of the web site. When the web page is rendered for viewing, the reusable content fragment is rendered according to a first format when the web page is rendered for the author of the page. Correspondingly, the reusable content fragment is rendered according to a second format when the web page is rendered for another user. The reusable content fragment may be inserted into other web pages of the web site from the reusable content library.

### BACKGROUND

Web sites are an integral part of an organization's operations. Web sites are used to actively promote companies and products, deliver services and information, manage transactions, and facilitate communications. Changes in site content may occur quickly—daily, hourly, or even minute-by-minute. These rapid changes may create a “ripple effect” of changes throughout a site. The sheer size of many dynamic business sites makes it impossible for all revisions to flow through a manager of the site or even a few site developers. Complexity and speed have created the demand for automated ways to effectively manage web content.

Web site content management products allow users to create and manage the pages of their web site and generate many automatic updates to the content. A web content management solution can enable an organization to save time and money, improve communications, strengthen business relationships, and increase revenues. Some content management systems also provide the scalability, flexibility, and enterprise system interoperability that is necessary to meet future site requirements. However, web content management solutions are still being developed, with many problem areas and developmental hurdles still need to be addressed.

For example, in many web sites, there are often common pieces of text or other content fragments which are usable on many pages. However, managing these common fragments has been difficult to accomplish. Many current web site management systems have yet to address these repeated fragments in a useful way.

### SUMMARY

Aspects of the present invention are generally related to managing reusable content fragments for a web site. A content management solution is included that is configured to provide locations in the site where the page authors may store reusable text and other content fragments. When creating new pages in the site, page authors may select a section of text or other content and save that as a reusable fragment. The fragment is saved in a reusable fragment library. Other authors may then insert the same fragment of text or other content into their pages. Whenever the fragment in the library is updated, all pages in the Web site which use that fragment are automatically updated as well.

In accordance with one aspect of the present invention, fragment creation and editing may be performed directly inside an author's normal editing environment. The author is not required to open another application and define the fragment before including the fragment in the web page being authored. Additionally, fragment creation and editing may also be performed from the fragment library. In one example, the fragment library shows the user the list of all fragments and supports sorting, filtering, and the like. The fragment library also supports sub-folders for organizing/categorizing related fragments.

In accordance with another aspect of the present invention, it is a reference to the fragment that is inserted within the web page editor rather than the fragment itself. Whenever a page of the site is viewed, the reference is dynamically removed and a current version of the fragment is inserted into the page.

In accordance with still another aspect of the invention, the content management system may be configured to allow the authors and/or designers to select a fragment and then view a list of the pages in the web site which are currently using that fragment. Additionally, the content management system is also configured to prevent a fragment that is currently being used in a page from being deleted.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is an exemplary embodiment of a computer system for providing an authoring view of a web page having a reusable content fragment;

FIG. 2 is a functional diagram illustrating an exemplary computing environment and a basic computing device that operates the content management application;

FIG. 3 is a functional diagram of an exemplary system for managing reusable content fragments;

FIG. 4 is an exemplary embodiment of a web page that illustrates an end user view of the web page;

FIG. 5 is an exemplary embodiment of an asset picker window for selecting a reusable content fragment;

FIG. 6 is an exemplary embodiment of a view of a reusable content library for storing reusable content fragments;

FIG. 7 is an exemplary embodiment of a window presented for creating and editing a reusable content fragment;

FIG. 8 is a flow diagram representing an exemplary embodiment for rendering a reusable content fragment; and

FIG. 9 is a flow diagram representing an exemplary embodiment for saving a reusable content fragment, in accordance with the present invention.

### DETAILED DESCRIPTION

Embodiments of the present invention are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments of the present invention may be practiced as methods, systems or devices. Accordingly, embodiments of the present invention may take the form of an entirely hardware implementation, an entirely software implementation or an implementation combining software and hardware aspects. The following detailed description is, therefore, not to be taken in a limiting sense.

The logical operations of the various embodiments of the present invention are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, steps or modules.

The present invention relates to embodiments of methods and systems that prohibit actions during a web page creation process. In embodiments of the present invention, the web page creation process has two phases: a web page template creation phase and a web authoring phase. A web page template is created during a web page template creation phase, and the web page template has at least one field. A field is an area within the web page template that allows dynamic editing within the field during the web authoring phase. In one embodiment, the field allows the inclusion, deletion, arrangement, or modification of content within the field. In embodiments of the present invention, one or more constraints are assigned to at least one of the fields. The constraints prohibit certain editing actions in the field, including the changes to field content mentioned above, during web authoring.

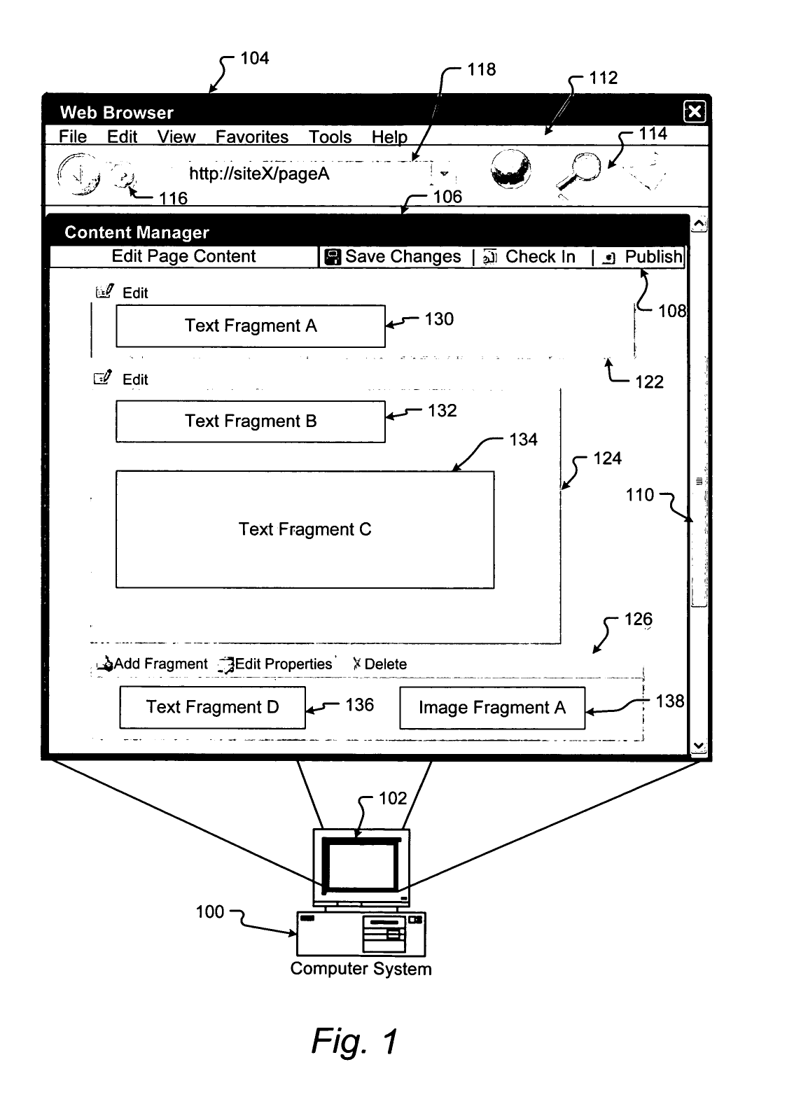

FIG. 1 is an exemplary embodiment of a computer system for providing an authoring view of a web page having a reusable content fragment in accordance with the present invention. As used herein, a “computing system” shall be construed broadly and is defined as one or more devices or machines that execute programs for displaying and manipulating text, graphics, symbols, audio, video, and/or numbers.

Computer system 100 displays information, such as display screen 102. Display screen 102 is enlarged to show details of the display. Display 102 relates to an over-simplified display of an example web browser application with the capability of viewing and editing content fragments. Importantly, although display 102 displays a web browser, many other types of software applications may be used to both generate content fragments and create the web page in accordance with the present invention and thus, the web browser example is not meant as a limitation, but merely as an illustration.

In this particular example, display 102 has a web browser window 104. Web browser window 104 has a menu bar 112 and a tool bar 114. Tool bar 114 provides user controls such as a back/forward navigation control 116, among potentially many others. Such user interface controls are generally known in the art and are useful in managing certain types of information. One such control in the current embodiment corresponds to navigation field 118. Navigation field 118 indicates the Uniform Resource Locator (URL) of the current page being viewed/edited and allows a user of web browser 104 to enter other URLs to navigate to other pages.

Since the current view of the page is an authoring view, within web browser window 104, there is a sub-window referred to as content manager window 106. In this particular example, content manager window 106 displays a set of content fields (122, 124, 126) that are included in the web page. The content fields, and the content within the fields may be managed according to another menu bar 108. More content fields may be available to include in a web page as represented by scroll bar 110.

Within each content field are one or more content fragments. The content fragments may correspond to text (e.g., text fragment A 130) or otherwise correspond to other types of content such as images (e.g., image fragment A 138). In one embodiment, the content of the fields is not logically separated into fragments. Instead, only those fragments of text or other content designated as reusable fragments are logically separated into fragments, and the remaining content is generally included in the fields. However, it may be that another option is to treat all content as fragments, with some fragments designated as reusable content fragments, and other fragments designated as general content fragments.

Text fragment C 134, text fragment D 136, and image fragment A 138 are each designated as reusable content fragments. In the present authoring view of the web page, these content fragments are highlighted to the page author (as indicated by the shading). As reusable content fragments, these fragments may be selected from a reusable content library (as described below) and inserted anywhere amongst the content of the fields. In one embodiment, the content manager allows the reusable content fragments to be created and edited directly within the authoring view of the page. In another embodiment, once the reusable content fragment is placed within the content of the page, the reusable content fragment is moved or deleted as a unit, treating the reusable content fragment similar to an embedded image.

In embodiments of the present invention, the field settings contain constraints. A constraint is a limitation or prohibition on a discrete action that may occur during web authoring. Constraints may take numerous forms and limit or prohibit many various discrete actions. In some embodiments, the constraints can limit the types of web parts that a web author can place in a field, can limit the types of manipulations or modifications to the web parts already part of a field, can limit the number of web parts allowed in a field, can prohibit certain types of arrangements of the web parts within the field, or can limit the property configurations allowed for types of web parts within the fields. One skilled in the art will recognize other types of constraints that may be applied to the fields and that the present invention is not limited to the specific embodiments of constraints described herein.

Field 126 is shown as having different constraints from fields 122 and 124. Field 126 is designated to accept only reusable content fragments. This ability to designate a field to correspond to only reusable content fragments is useful when consistent use of the field is required for each page within a web site. For example, a field may be designated on each page of the web site for providing the copyright notice of the page. To maintain the consistent use of the copyright notice throughout the web site, the author of the page is limited to the content that may be included in the field. Limiting the author to inserting reusable content fragments ensures that the author's presentation of the copyright notice is consistent with other pages of the web site. Additional constraints provided by the field may be leveraged to minimum number or maximum number of reusable fragments which may be inserted into the field as well as the type of reusable fragments. These constraints may be leveraged in various combinations. For example, the field may be configured to require a minimum of 1 reusable fragment, a maximum of 1 reusable fragment, and require that the type of fragment be a copyright notice.

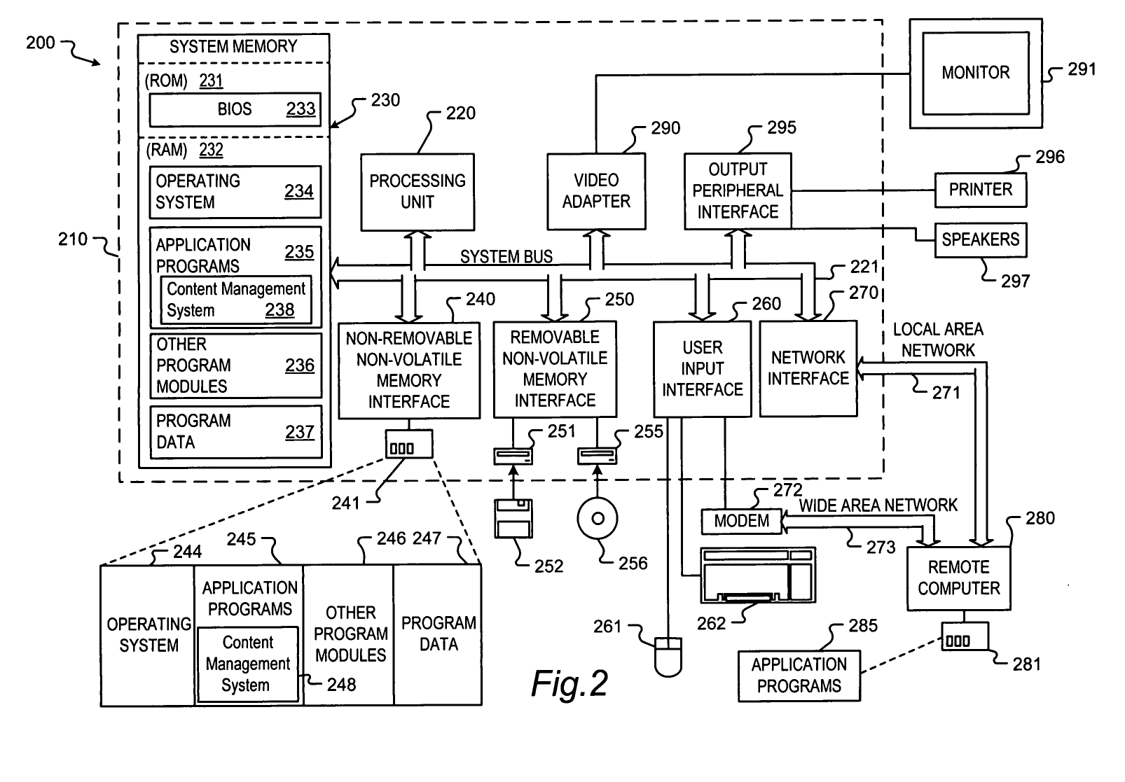

FIG. 2 illustrates an example of a suitable computing system environment 200 on which the invention may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary computer system 200 for implementing the invention includes a general purpose-computing device in the form of a computer 210. Components of the computer 210 may include, but are not limited to, a processing unit 220, a system memory 230, and a system bus 221 that couples various system components including the system memory 230 to the processing unit 220. The system bus 221 may be any of several types of bus structures including a memory bus or memory controller, a peripheral bus, or a local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnect (PCI) bus, also known as the Mezzanine bus.

Computer 210 typically includes a variety of computer readable media. Computer readable media can be any available media that can be accessed by the computer 210 and includes both volatile and non-volatile media and removable and non-removable media. By way of example, and not limitation, computer readable media may comprise computer storage media and communication media. Computer storage media includes volatile, non-volatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of the any of the above should also be included within the scope of computer readable media.

The system memory 230 includes computer storage media in the form of volatile and/or nonvolatile memory, such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237; a web page created from a web page template, such as web page template 144, would be stored as program data and displayed from RAM 232.

The computer 210 may also include other removable/non-removable, volatile/non-volatile computer storage media. By way of example only, FIG. 2 illustrates a computer 210 with a non-removable, non-volatile memory interface 240 that reads from or writes to non-removable, non-volatile magnetic media 241, such as a hard drive. Computer 210 may also include a non-volatile memory interface 250 that reads from or writes to a device 251, such as a disk drive, that reads from or writes to a removable, non-volatile media 252, such as a magnetic disk. In addition, the computer 210 may include an optical disk drive 255 that reads from or writes to a removable, non-volatile optical disk 256, such as a CD ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface, such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules, and other data for the computer 210. For example, hard disk drive 241 is illustrated as storing operating system 244, application programs 245, other program modules 246, and program data 247, which can either be the same as or different from operating system 234, application programs 235, other program modules 236, and program data 237. Operating system 244, application programs 245, other program modules 246, and program data 247 are given different numbers here to illustrate that, at a minimum, they are different copies. Additionally, a content management system 238 (and 248) is shown as being included in application programs 235/245 for implementing the functionality provided according to the present invention. However, the data and instructions associated with content management system 238 (may 248) may also be included as other program modules (e.g., 236/246), other program data (e.g., 237/247), integrated with operating system 234/244, or included in other stored instructions or data without departing from the spirit or scope of the invention.

A user may enter commands and information into the computer 210 through a user input interface 260 connected to user input devices, such as a keyboard 262 and pointing device 261, commonly referred to as a mouse, trackball, or touch pad. Other input devices (not shown) may include a microphone, joystick, game pad, satellite dish, scanner, or the like. These and other input devices are often connected to the processing unit 220 through a user input interface 260 that is coupled to the system bus 221, but may be connected by other interfaces and bus structures, such as a parallel port, game port, or a universal serial bus (USB).

A monitor 291 or other type of display device is also connected to the system bus 221 via an interface, such as a video interface 290. In addition to the monitor 291, the computer 210 may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device, or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks, such as wireless networks. Such networking environments are commonplace in offices, enterprise-wide computer networks, intranets, and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device 281. By way of example, and not limitation, the remote application programs 285 reside on memory device 281. It will be appreciated that the network connections shown are exemplary and other means of establishing a communications link between the computers may be used.

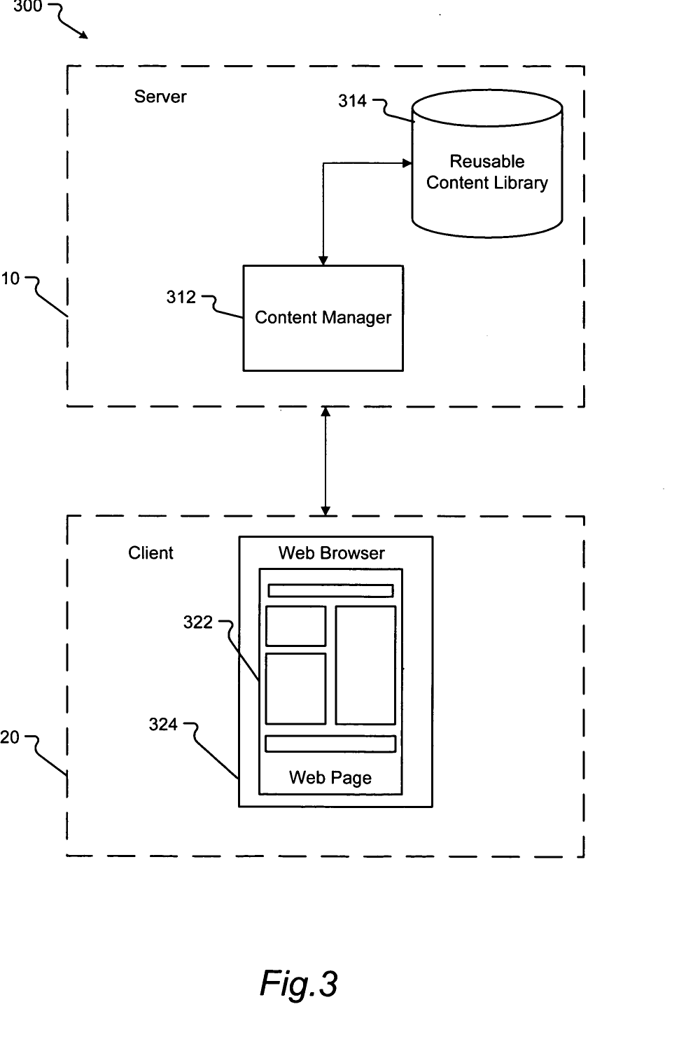

FIG. 3 is a functional diagram of an exemplary system for managing reusable content fragments, in accordance with an embodiment of the present invention. System 300 is provided to illustrate that the processes for providing web page 322 with included reusable content fragments is controlled by interoperation between a server (e.g., 310) and a client (e.g., 320).

Server 310 includes content manager 312 and reusable content library 314. In another embodiment, reusable content library 314 may be stored on a third party computer system. Content manager 312 is provided to transmit the data and instructions to client 320 for rendering web page 322 within web browser 324. The data and instructions provided also include the data corresponding to reusable content fragments that may be included in web page 322.

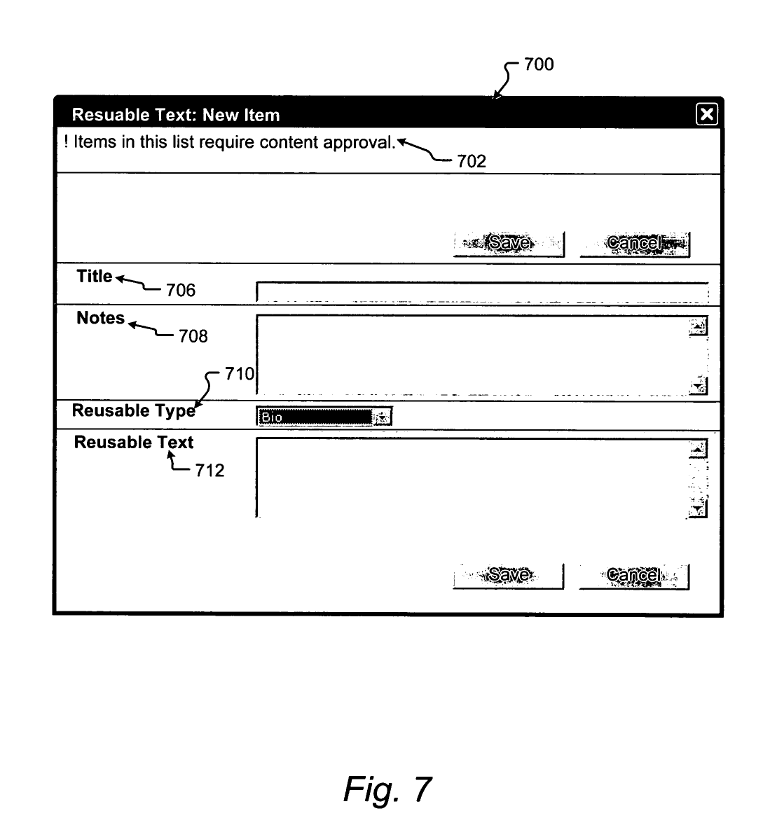

For example, the author of a page may be about to create three new product pages about a new line of rain jackets their company is announcing. As the author creates the first page, the author has also created a nicely formatted table that compares the features of the three jackets. The author desires to use this table on the product page for each jacket. The author selects the table and selects a “Create a new reusable fragment” option (e.g., a toolbar button). The author is then presented with a window (e.g., editing window 700 in FIG. 7) asking for the title of the reusable fragment and its type (copyright, about company, product info, etc.). The author may then enter the title, select the type, and then confirm the creation of the reusable fragment. Additionally, the author may specify the location where the fragment is to be stored. For example the author may select that the reusable content fragment be stored in a folder within the reusable content library. Furthermore, a number of default parameters may be added to the reusable content fragment so that a location is chosen for the reusable content fragment based on the parameters. In one embodiment, the default parameters are unique for each web site that the where the author is editing the web pages.

When the editing window closes, the author notices that the table is no longer editable and has a new user interface treatment (e.g., highlighting) indicating that the table corresponds to a reusable fragment. The rendering of a page, including the interface changes, is handled by client 320. In contrast, the management of the actual content included in web page 322, as well as storage of the reusable content fragment, is handled by server 310.

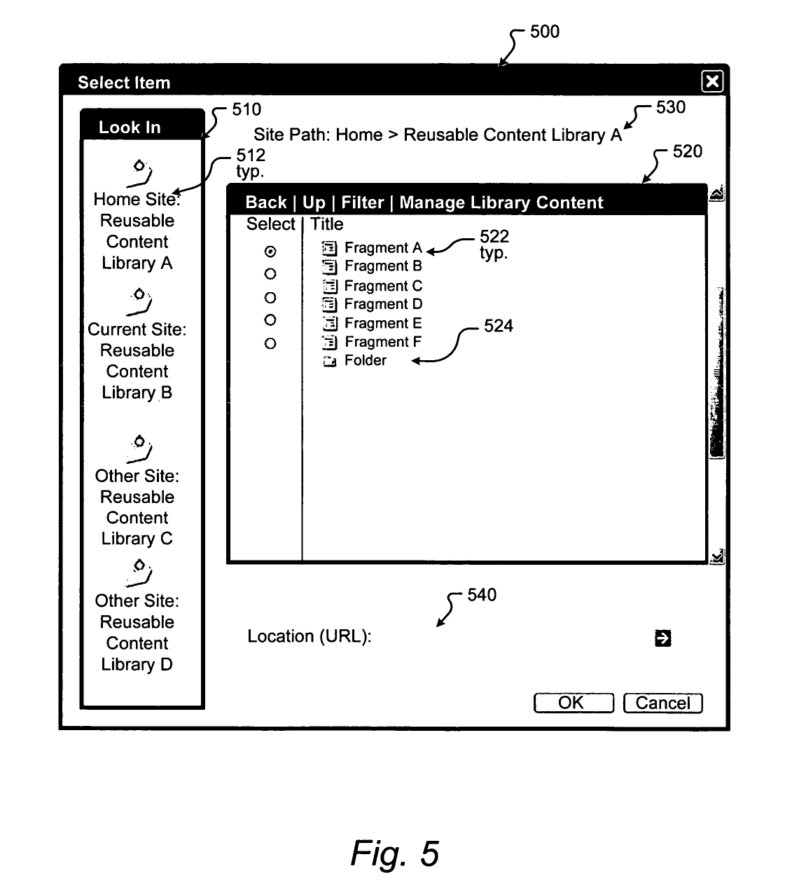

Similarly, when the author moves to create the pages for the other two jackets, the author may then select an “Insert an existing reusable fragment” option. The author is then presented with an asset picker window (e.g., asset picker window 500 in FIG. 5) showing the author the reusable fragments that may be selected from reusable content library 314. The author then may select the jacket comparison table fragment included in the library. Again, when the window closes, the author views the same table as the first jacket product page with the same highlighting and other features. Again, communication of the reusable content library and the selected content fragment is managed by server 310, but rendering the asset picker window and user interface for selecting a fragment is handled by client 320.

From system 300, it is apparent that at least one embodiment of the present invention is an integrated client-server process for managing reusable content fragments in a web site. It is appreciated that other processes may also be provided, including an entirely client-based process, as well as a substantially server-based process, without departing from the spirit or scope of the present invention.

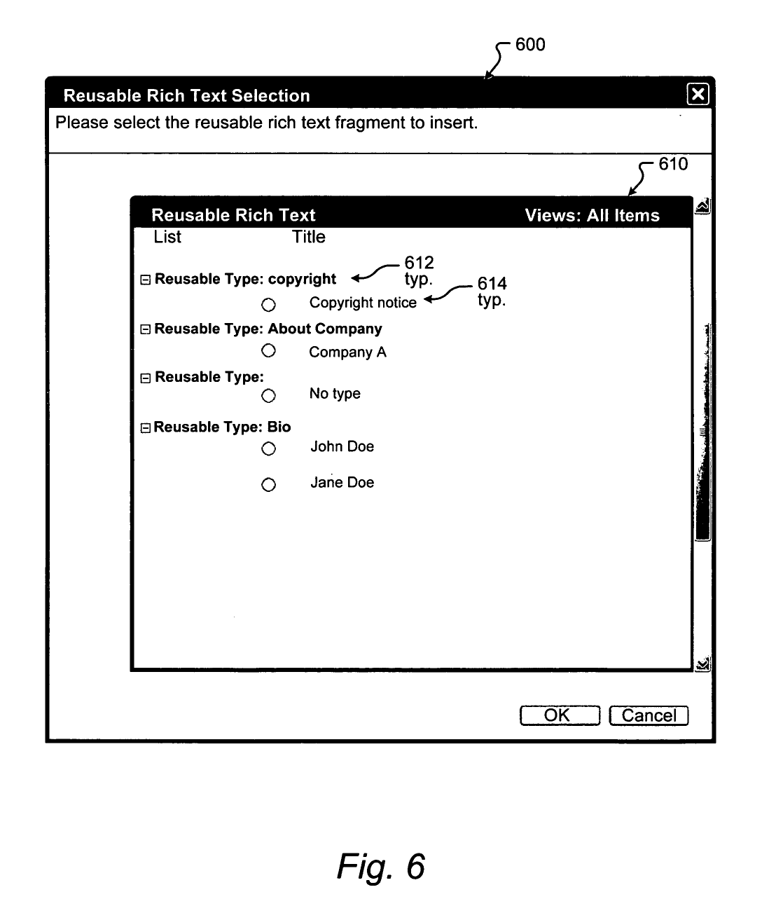

An additional process that may be used in the context of system 300 is a dependency determination process. For example, a particular author may manage a particular reusable content fragment. The author may desire to find all of the pages in the site that use the fragment the author manages. The author may open a view to the reusable content library (e.g., view 600 shown in FIG. 6). An option may be included to view related items of the managed fragment, which shows all the pages that depend on the reusable content fragment the author manages. If the manager decides to edit or delete the managed fragment, the author can change the fragment and have that change propagated across all pages. In one embodiment, if the author simply deletes the fragment, an error message may result if the fragment is in use by any page in the web site. Instead the author is required to rename the fragment to indicate its obsolete status (e.g., “copyright 3—obsolete—do not use). Additionally, an expiration date may be added onto the reusable content fragment so that fragments that have expired are no longer be available for the page author to select. However, the reusable content fragment that have expired continue to be available for existing web pages that already include the fragment. After all of the pages using the fragment have been modified so that they no longer use the fragment and the page have subsequently been approved and published, there will no longer be any page using the fragment and the author is then able to successfully delete the fragment. Accordingly, dependencies of the fragment among pages of the web site are managed to ensure that the integrity of each page is maintained.

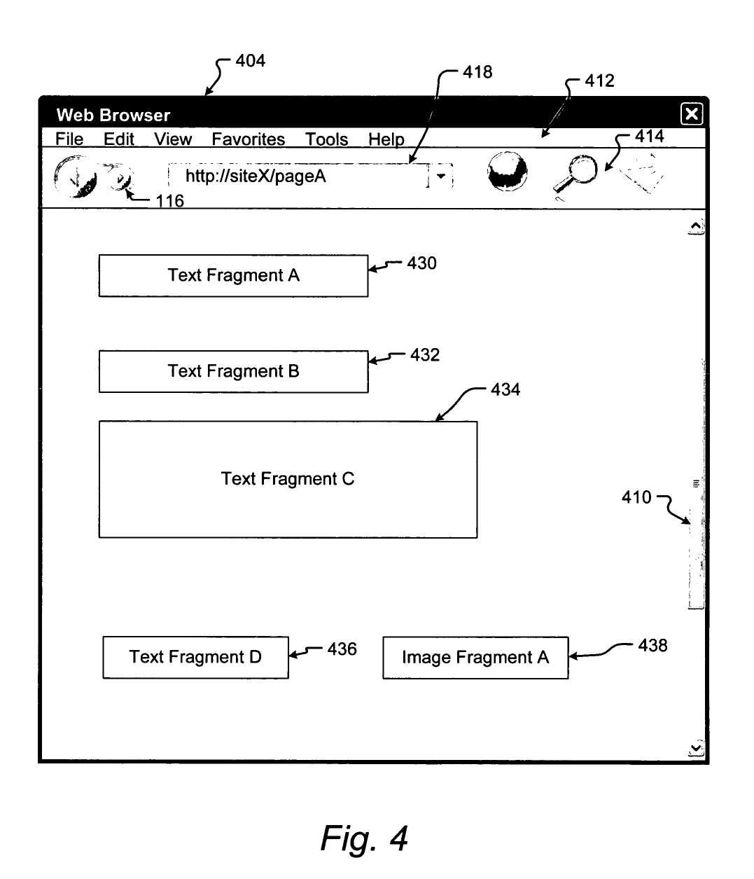

FIG. 4 is an exemplary embodiment of a web page that illustrates an end user view of the web page, in accordance with one embodiment of the present invention. In contrast to the authoring view shown in FIG. 1, the end user view does not show any editing functionality for manipulating the text of the web page. A similar web page interface 404 is illustrated, along with the menu bar 412 and tool bar 414. Tool bar 414 includes similar web page controls (e.g., 416 and 418), however the content of the web page has changed. The editing controls associated with the content manager window are no longer included. Furthermore, the editing features that are associated with each of the fields are also not presented to the end user. By not including the editing artifacts, the fidelity of the web page (e.g., the HTML of the web page) is maintained allowing the end user to be presented with a web page with unified content.

With regard to the reusable content fragments, reusable content fragments 434, 436, and 438 are not highlighted to the user as are their counterparts in FIG. 1. Although, the content of the page is still shown as separated into fragments, this is by way of illustration for comparison only. A true end user view of the web page would not delineate among fragments. An end user would instead view an unbroken page of content and not be aware that certain portions of the content were treated as separate content fragments. Accordingly, from the end user perspective, the reusable content fragments are integrated seamlessly into the web page.

FIG. 5 is an exemplary embodiment of an asset picker window for selecting a reusable content fragment, in accordance with one embodiment of the present invention. Asset picker window 500 includes a directory field 510, a library content field 520, a site path indicator 530, and a location selection field 540.

Directory field 510 allows the author of a web page to select among a group of libraries available for the library from which the author desires to select a reusable content fragment. Each library (e.g., 512) is indicated by its location relevant to the current web site and an identifier or title of the library. In one embodiment, the web site does not allow for a selection amongst various reusable content libraries, but instead stores the reusable content library applicable to the web site at the web site's root location. Once a selection of a particular library is made, the location of the selected library is indicated in site path indicator 530. In an alternative embodiment, the selection of the library may be made by inserting the URL location of the library into location selection field 540.

The contents of the selected reusable content library are then shown in library content field 520. Library content field shows a list of fragments (e.g., 522) and folders (e.g., 524) for selecting a particular fragment for insertion into the web page. As shown, each library may be organized into a listing of fragments or into a listing of folders and sub-folders each including more reusable content fragments for selection.

Asset picker window 500 may be instantiated at any time corresponding to any location of the web page for fields that permit the use of reusable content fragments. In certain circumstances, the libraries available for a particular web site may be limited to a particular set of libraries. Furthermore, certain reusable content libraries may be designated as being associated with a particular site, and therefore are not usable by other web sites for inserting reusable content fragments.

FIG. 6 is an exemplary embodiment of a view of a reusable content library for storing reusable content fragments, in accordance with one embodiment of the present invention. Reusable content library 600 corresponds to a portion of the library that is associated with reusable rich text fragments. In one embodiment, the reusable content fragments are differentiated amongst the different types of content the fragments represent. For example, the reusable content fragments may be differentiated between fragments that correspond to plain text, fragments that correspond to rich text, fragments that correspond to HTML (hypertext markup language) content, and the like. In additional embodiments, the available content types that differentiate the types of content may be user defined.

The view 600 of the reusable content library includes a selection window 610 for selecting the rich text fragment to insert into the web page. Selection window 610 provides an alternative selection window to the asset picker window 500 shown in FIG. 5. Selection window 610 includes a listing of the types of reusable content fragments available (e.g., 612) and the actual fragments associated with each type (e.g., 614). Listing the fragments according to their type provides another example for hierarchically storing the fragments similar to the folder and file listing shown in FIG. 5.

FIG. 7 is an exemplary embodiment of a window presented for creating and editing a reusable content fragment, in accordance with one embodiment of the present invention. Editing window 700 shown corresponds to a creation of a new reusable fragment (i.e., title indicates a new item). However, a fragment that is already saved to the reusable content library and is inserted into a web page may also be edited through editing window 700.

Editing window 700 includes an optional notification 702 that indicates that the changes to an existing reusable content fragment and/or the creation of a new content fragment are subject to approval before being stored to the reusable content library. A web site may have a variety of web page authors. If each of these web page authors have inserted a particular reusable fragment onto their page, an edit to the fragment may not be allowed. The edit to the reusable content fragment may need to pass an automatic or manual approval process before the new or edited reusable content fragment may be used.

Fields 706, 708, 710, and 712 are user defined fields for creating and identifying the reusable content fragments. Field 706 corresponds to the title of the reusable content fragment. Field 706 may provide an indication of what the fragment is (e.g., “2005 copyright notice), or may just provide an arbitrary designator for the reusable content fragment. Field 708 corresponds to a notes field for the author. The notes field provides the author of the reusable text fragment to describe the fragment's general use and other information about the fragment. In one embodiment, field 708 provides a quick reference that describes the fragment's contents rather than forcing the author of the web page to examine the fragment in its entirety. Field 710 provides a field for entering the type of the reusable fragment. In one embodiment, the types of reusable content fragments are limited to a particular set of types. In the example shown, a bio type of reusable content fragment is being selected from among the available types. Field 712 is provided for entry of the actual text that corresponds to the reusable content fragment. As shown in the label for editing window 700, the editing window is provided for creating/editing of a reusable text fragment. It is contemplated that a similar window is also provided for creating/editing content types other than text. Additionally, an expiration date field (not shown) may be included with the new reusable content fragment that sets an expiration date for the reusable content fragment. Any reusable content fragment that has an expiration date that indicates that the fragment has expired, is no longer available for an author to select from the reusable content library.

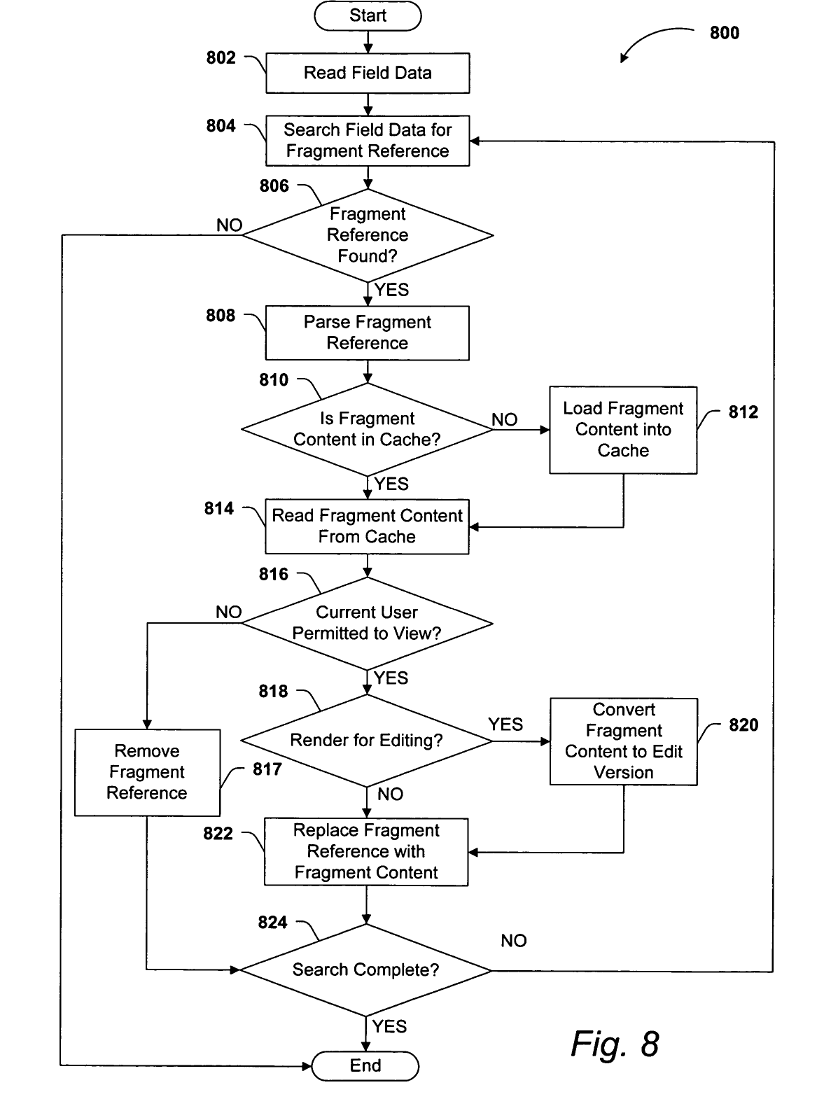

FIG. 8 is a flow diagram representing an exemplary embodiment for rendering a reusable content fragment, in accordance with one embodiment of the present invention. When process 800 starts, a web page has been created that includes one or more reusable content fragments within a field of the page. Processing then continues with read field data operation 802.

Read field data operation 802 reads the data corresponding to the field in the web page into memory for processing. In one embodiment the field that is read is identified according to a field value that uniquely identifies the field from other fields within the web page. Once the field data is read into memory, processing continues to search operation 804.

Search operation 804 searches the field data for reusable content fragment references. In one embodiment, when the filed data is stored as HTML, the reusable content fragment references correspond to one or more tags in the HTML that reference the separately stored reusable content fragment. As the field data is searched, processing continues at a decision operation 806.

Search decision operation 806 makes a determination during search operation 804 of whether a reusable content fragment reference is found in the field data. If a reusable content fragment reference is not found, process 800 ends and processing moves onto other tasks for handling the field data and rendering the web page. If a reusable content fragment reference is found in the field data, then processing continues with parse operation 808.

Parse operation 808 parses the reusable content fragment reference to determine the identifier for the fragment and other information for identifying and locating the reusable content fragment in memory. Once the reusable content fragment is identified by parsing the fragment reference, processing continues at cache decision operation 810.

Cache decision operation 810 determines whether the fragment data or fragment content corresponding to the reusable content fragment reference found is already present in the cache or other storage of the local computing device on which the web page is being rendered. If the fragment content is not in the cache then processing moves to load operation 812.

Load operation 812 loads the fragment content based on the fragment identification information into the cache of the local computing device. The fragment content is obtained from the stored version reusable content library. Once the fragment content is loaded, or if the fragment content was determined to already reside in the cache from cache decision operation 810, processing continues at read content operation 814.

Read content operation 814 reads the fragment content from the cache. The content of the reusable content fragment corresponds to the information required by the web page for rendering the reusable content fragment within the field. After the fragment content is read from the cache, processing continues to permission decision operation 816.

Permission decision operation 816 determines whether the current user of the web page has permission to view the reusable content fragment. It may be that a property associated with the reusable content fragment has been set to prevent the user from viewing the reusable content fragment. If so, then processing moves to conversion operation 817. Conversion operation 817 removes the reusable content fragment reference from the field data and does not replace it with any content. Processing then continues to search decision operation 824 to search for the field data for additional reusable content fragments.

However, if the current user does have permission to view the reusable content fragment, then processing continues with a rendering type decision operation 818. Rendering type decision operation 818 determines whether the type of rendering being done is to produce an editing or author's view of the web page or to produce the web page for an end user. If the web page is being rendering for editing, processing moves to conversion operation 820.

Conversion operation 820 converts the reusable content fragment to an edit version of the fragment. The edit version adds content and allows edits to the fragment to be made. In one embodiment, the fragment is highlighted to differentiate the fragment from the surrounding content of the field. Once the reusable content fragment is converted, or it is determined by rendering type decision operation 818 that no such conversion is necessary, processing continues with replacement operation 822.

Replacement operation 822 replaces the fragment reference in the HTML with the fragment content corresponding to the selected version of the reusable content fragment. Once the fragment content is inserted into the rendering description of the field, processing continues with search decision operation 824.

Search decision operation 824 determines whether the search of the current field data for reusable content fragments is complete. Each field may contain multiple reusable content fragments. If the search is incomplete, processing returns to search operation 804 where the search continues. However, if the search of the field data is complete, process 800 ends and processing moves onto other tasks for handling the field data and rendering the web page.

Process 800 may be repeated as many times as necessary for the various fields that may be included in a particular web page. Once process 800 is completed for each field, then the rendering controls of the web browser take the HTML provided and convert the HTML to a rendered image of the web page. Again, the web page presented is determined, at least in part, by whether the web page is presenting author's view or an end user's view of the page.

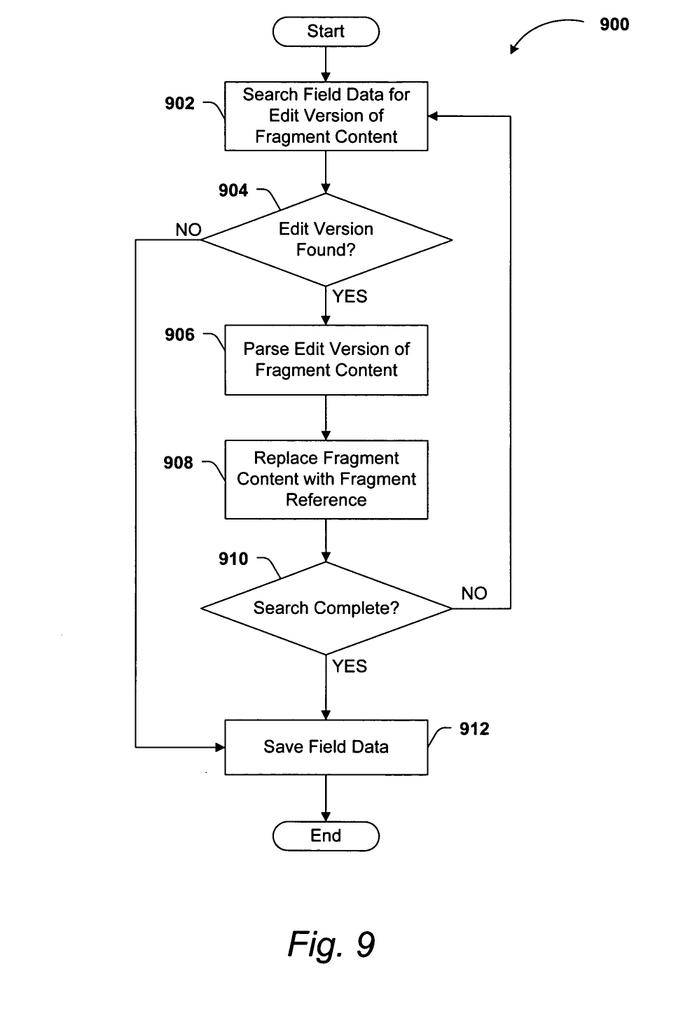

FIG. 9 is a flow diagram representing an exemplary embodiment for saving a reusable content fragment, in accordance with the present invention. When process 900 starts, a version of a web page that includes at least one field has been rendered. Processing continues at search operation 902.

Search operation 902, searches the data representing the rendered version (e.g., HTML version) of a field on the web page for data representing an edit version of a reusable content fragment. The edit version of the reusable content fragment corresponds to the version of the fragment rendered for an author of the web page. The edit version of the reusable content fragment is in contrast to an end user view of the same fragment. The edit version may contain addition information, as well as highlighting the reusable content fragment for the author to identify itself as a reusable fragment. As the field data is searched, processing continues to version decision operation 904.

Version decision operation 904 determines whether an edit version of a reusable content fragment is found in the field data. If no edit version is found, processing advances to save operation 912 where the field data is saved. However, if an edit version of a reusable content fragment is found, processing continues at parse operation 906.

Parse operation 906 parses the edit version of the fragment content included in the field data. The parse operation determines the identifying information associated with the fragment content and other information used for saving the reusable content fragment. In one embodiment, parsing the fragment content identifies the reusable content fragment as a new fragment or an edited existing fragment within the field. In another embodiment, when the fragment content is parsed, and change has occurred to the content, the changed fragment is forwarded to the reusable content library. The reusable content library then updates the reusable content fragment within the library for future requests for the reusable content fragment. In still another embodiment, the change to the reusable content fragment is submitted to an approval process before the reusable content library is updated. Once the fragment content is parsed, processing continues at replacement operation 908.

Replacement operation 908 replaces the fragment content with a fragment reference. The fragment reference may be obtained from the reusable content library in the case of an existing reusable content fragment, or may be generated for a new reusable content fragment. Once the fragment content is replaced with the fragment reference, processing continues at search decision operation 910.

Search decision operation 910 determines whether the search of the rendered field data for edit versions of fragment content is complete. Each field may contain multiple reusable content fragments. If the search is incomplete, processing returns to search operation 902 where the search continues. However, if the search of the field data is complete, processing continues to save operation 912.

Save operation 912 saves the field data for that particular field, now including the fragment references rather than the fragment content, to the cache. From the cache, the field data may be forwarded to a server and stored. In another embodiment, the remaining fields of the web page may also have process 900 applied before saving the field data. Instead of saving each set of field data individually, the field data is saved as a portion of the saved web page. Once the field data is saved, process 900 ends and processing continues to other tasks for saving the web page or manipulating the page.

Similar to process 800, process 900 may be repeated as many times as necessary for the various fields that may be included in a particular web page. Once process 900 is completed for each field, a saved version of the web page that represents the latest version of the web page is stored in the content management system.

In addition to the operations described in processes 800 and 900, operations may also be included when saving and rendering reusable content fragments that is related to the formatting (e.g., font, text color, bold, italic etc) of the reusable content fragment. Options may be provided so that a reusable content fragment may preserve the formatting or apply a different formatting to the content of the fragment. For example, a reusable content fragment may contain references to cascading style sheets (CSS) classes that mark up the content. However, the actual formatting is tied to the web page that consumes the fragment. Returning to the example of the web site for selling jackets previously described. There may be three web pages for three jackets that each have a unique color. It is desired that the table display the appropriate color for a particular web page. Although the material content of the table is the same when rendered in each page for each jacket, the color scheme of the table may be different (e.g., on the page for a yellow jacket, the yellow color is shown first on the table. In contrast, a user may desire that no variation of the formatting for a particular reusable content fragment be permitted. In this example, the formatting may be hard coded within the reusable content fragment so that the consuming page is forced to respect the formatting. As a result, the content is displayed as specified with the reusable content fragment (e.g., using inline style formatting).

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method for managing reusable content in a web site, the method comprising:
saving a reusable content fragment in a reusable content library in response to creation of the reusable content fragment within a first web page of the web site;
rendering the reusable content fragment in the first web page when the first web page is viewed, wherein the reusable content fragment is rendered according to a first format when the first web page is rendered for the author of the first web page, and the reusable content fragment is rendered according to a second format when the first web page is rendered for another user; and
inserting the reusable content fragment in a second web page of the web site in response to a request to insert the reusable content fragment, wherein the inserted reusable content fragment is obtained from the reusable content library.

2. The computer-implemented method of claim 1, wherein changes to the reusable content fragment within the reusable content library are reflected in the first web page.

3. The computer-implemented method of claim 2, wherein changes to the reusable content fragment within the reusable content library are further reflected in the second web page.

4. The computer-implemented method of claim 1, wherein changes to the reusable content fragment within the first web page are reflected within the reusable content library.

5. The computer-implemented method of claim 1, further comprising:
searching field data of a field included in the first web page for data representing the reusable content fragment being rendered according to the first format;
parsing the data representing the reusable content fragment being rendered according to the first format when found;
replacing the data representing the reusable content fragment being rendered according to the first format with a fragment reference; and
saving the field data to provide a new representation of the field of the first web page.

6. The computer-implemented method of claim 5, wherein searching the field data, parsing the data, replacing the data, and saving the field is repeated for each field included in a web page, such that a new representation of the web page is provided.

7. The computer-implemented method of claim 1, wherein rendering the reusable content fragment in the first web page further comprises:
searching field data of a field included in the first web page for a fragment reference;
parsing the fragment reference when found; and
replacing the fragment reference with fragment content corresponding to the reusable content fragment; and
rendering the field when the first web page is rendered, such that the fragment content represents the rendered reusable content fragment.

8. The computer-implemented method of claim 7, wherein replacing the fragment reference with fragment content further comprises:
determining whether the fragment content is located in a cache associated with the first web page;
loading the fragment content into the cache from the reusable content library when the fragment content is not already located in the cache; and
reading the fragment content from the cache when the fragment content is in the cache.

9. The computer-implemented method of claim 7, further comprising:
determining whether a current user of the web page is permitted to view the reusable content fragment; and
preventing the reusable content fragment from rendering when the current user is not permitted to view the reusable content fragment.

10. The computer-implemented method of claim 7, wherein the field includes a constraint that defines the field data that the field is allowed to include, wherein constraint is directed to at least one of limiting the field to including only reusable content fragments, limiting the field to include a specified number of reusable content fragments, and limiting the field to using reusable content fragments of a particular type.

11. The computer-implemented method of claim 1, further comprising protecting the dependencies of the reusable content fragment by requiring that changes to the reusable content fragment within the first web page and the second web page be approved.

12. The computer-implemented method of claim 1, wherein the first format corresponds to a format associated with when the first web page is being edited.

13. The computer-implemented method of claim 12, wherein the reusable content fragment is highlighted according to the first format.

14. The computer-implemented method of claim 1, further comprising providing a separate editing window for editing the reusable content fragment after the reusable content fragment is saved to the reusable content library.

15. The computer-implemented method of claim 1, further comprising a providing a separate asset picker window for selecting the reusable content fragment from the reusable content library when the reusable content fragment is inserted into the second web page.

16. The computer-implemented method of claim 1, further comprising associating formatting instructions with the reusable content fragment, wherein a first set of instructions allows formatting to be applied to the reusable content fragment in addition to formatting applied by the first web page, and wherein a second set of instructions separately applied to the reusable content fragment prevents formatting from being applied to the reusable content fragment other than formatting directly associated with the reusable content fragment.

17. A computer-readable medium having stored thereon instructions that when executed implement the computer-implemented method of claim 1.

18. A system for managing reusable content in a web site, comprising:
a reusable content library that is configured to store a reusable content fragment, wherein the reusable content fragment is included in a web page of the web site; and
a content manager that is configured to provide data representing the reusable content fragment to a web browser such that the web browser is facilitated in rendering the web page including the reusable content fragment, wherein changes to the reusable content fragment in the reusable content library are reflected in the web page.

19. A computer-readable medium having stored thereon instructions that when executed implement the system of claim 17.

20. A computer-readable medium having stored thereon computer-executable instructions for managing reusable content in a web site, the computer-executable instructions comprising:
searching field data of a field included in a web page of the web site for a fragment reference;
parsing the fragment reference when found;
replacing the fragment reference with fragment content corresponding to a reusable content fragment stored in a reusable content library;
rendering the field, such that the fragment content represents the rendered reusable content fragment;
searching field data of a field included in the web page for data representing the reusable content fragment being rendered according to an edit version;
parsing the data representing the reusable content fragment being rendered according to the edit version when found;
replacing the data representing the reusable content fragment being rendered according to the edit version with a fragment reference; and
saving the field data to provide a new representation of the field of the web page.
